(19) United States
(12) Patent Application Publication
(10) Pub. No.: US 2005/0125299 A1
(43) Pub. Date: Jun. 9, 2005

(54) Method for operating a foodstuff related business

(76) Inventor: Donna M. McCole, Coatesville, PA (US)

Correspondence Address: RATNERPRESTIA, P O BOX 980, VALLEY FORGE, PA, 19482-0980, US

(21) Appl. No.: 10/728,469

(22) Filed: Dec. 5, 2003

(51) Int. Cl. G06G 1/12

(52) U.S. Cl. 705/21

(57) ABSTRACT

A method of operating a foodstuff related business includes selling a foodstuff product to a customer and packaging the foodstuff product in a package. The method also includes retrieving a digital image of the customer using a computer and applying a label including the digital image to the package.

### FIELD OF THE INVENTION

This invention relates to operating a foodstuff related business, and more particularly, to packaging of baked goods in connection with the foodstuff related business.

### BACKGROUND OF THE INVENTION

Foodstuff related businesses utilize a number of marketing approaches in selling their products and services. For example, certain fast food restaurants and pizza restaurants provide child play areas in order to attract customers with children. Additionally, such fast food restaurants and pizza restaurants may provide customers with opportunities to utilize the restaurant and play areas for certain child-related events (e.g., birthday parties, holidays, etc.).

However, such marketing approaches are widely used, and as such, their effectiveness is limited. Additionally, such play areas can be dangerous and unsanitary, and it may be difficult for customers to effectively monitor child guests in these play areas. Further, certain customers desire to have such child-related events in a family-oriented atmosphere, and one that is more controlled.

Therefore, it would be desirable to provide a method of operating a foodstuff related business having increased marketing potential, and overcoming at least one of the above-mentioned deficiencies of existing foodstuff related businesses.

### SUMMARY OF THE INVENTION

According to an exemplary embodiment of the present invention, a method of operating a foodstuff related business is provided. The method includes selling a foodstuff product to a customer and packaging the foodstuff product in a package. The method also includes retrieving a digital image of the customer using a computer and applying a label including the digital image to the package.

According to another exemplary embodiment of the present invention, another method of operating a foodstuff related business is provided. The method includes obtaining a digital image of a customer of the foodstuff related business. The digital image is linked to a label template stored in a memory of a computer system. The label including the label template with the digital image is then printed and applied to a package of a foodstuff related product of the foodstuff related business.

According to yet another exemplary embodiment of the present invention, a method of operating a baked goods business is provided. The method includes selling a baked good to a customer, and providing an area for the customer to decorate the baked good sold to the customer. The method also includes packaging the baked good decorated by the customer. Further, the method includes taking a digital picture of the customer and downloading the digital picture to the computer as a digital image. Further still, the method includes linking the digital image to a label template stored in a memory of the computer, printing a label including the label template with the digital image, and applying the printed label to the packaged baked good.

### BRIEF DESCRIPTION OF THE DRAWINGS

Exemplary embodiments of the invention will be described with reference to the drawings, of which:

FIG. 1 is a block diagram of a foodstuff related business location in accordance with an exemplary embodiment of the present invention;

FIG. 2 is a flow diagram illustrating a method of operating a foodstuff related business in accordance with an exemplary embodiment of the present invention;

FIG. 3 is another flow diagram illustrating a method of operating a foodstuff related business in accordance with an exemplary embodiment of the present invention;

FIG. 4 is a flow diagram illustrating a method of operating a baked goods business in accordance with an exemplary embodiment of the present invention;

FIG. 5 is an illustration of a group of label templates in accordance with an exemplary embodiment of the present invention;

FIG. 6 a detailed illustration of one of the label templates of FIG. 4;

FIG. 7 is an illustration of a label configured for application to a foodstuff product package in accordance with an exemplary embodiment of the present invention; and

FIG. 8 is a block diagram illustrating digital image processing equipment utilized in accordance with an exemplary embodiment of the present invention.

### DETAILED DESCRIPTION OF THE INVENTION

Preferred features of embodiments of this invention will now be described with reference to the figures. It will be appreciated that the spirit and scope of the invention is not limited to the embodiments selected for illustration. Also, it should be noted that the drawings are not rendered to any particular scale or proportion. It is contemplated that any of the configurations and materials described hereafter can be modified within the scope of this invention.

As used herein, the term customer interchangeably refers to any person connected to a customer of a foodstuff related business. For example, if an individual adult person completes a transaction or makes an agreement with the foodstuff related business, any other person connected with the individual person may be considered as a customer of the foodstuff related business. For example, a child of the individual person, an adult friend of the individual person, and a child of an adult friend of the individual person are all exemplary customers within the scope of the present invention.

As used herein, the term foodstuff refers to a broad class of substances that can be used as food or that may be prepared for use as food. Exemplary foodstuff items within the scope of the present invention include, but are not limited to, cookies (e.g., sugar cookies, gingerbread cookies, chocolate chip cookies), other baked goods (e.g., cakes, gingerbread houses, sugar cookie houses, cupcakes), and pizzas.

As used herein, the phrases “selling a foodstuff product to a customer” or “selling a baked good to a customer” refer to a broad range of sales activities. For example, the foodstuff product or baked good may be a single item, such as a single cookie or gingerbread house. Alternatively, the foodstuff product or baked good may refer to a group of such items, for example, a group of five cookies. Whether the foodstuff product or baked good refers to a single item or a group may be determined by the individual who decorates the foodstuff product or baked good (e.g., a child), by the customer who ultimately pays for the service (e.g., a parent), or by the business that offers the baked goods as a menu selection in the activity bakery area.

In accordance with the present invention, a baked good sold to the customer is not necessarily baked at the time that the customer initially receives the baked good. For example, the baked good may initially be provided to the customer as a pre-mixed baking dough compound that the customer may roll (e.g., with a rolling pin) and cut (e.g., with cookie cutters) into desired shapes. The baked good may then be baked and brought back to the customer for decorating and subsequent packaging.

In one embodiment of the present invention, an individual or small group of customers (e.g., a child alone, or a parent with a child) purchases a foodstuff product or baked good to be decorated and packaged as described herein. Alternatively, a person hosting an event (e.g., a child's birthday party, a corporate event, a class, a baking class) may purchase the use of the baking and packaging facility so that a number of customers (e.g., children at the event) may decorate and receive packaged foodstuff products as described herein. Further, the customer who purchases the foodstuff product or baked good may be any of the broad class of customers defined above (i.e., any person connected to a customer of the foodstuff related business).

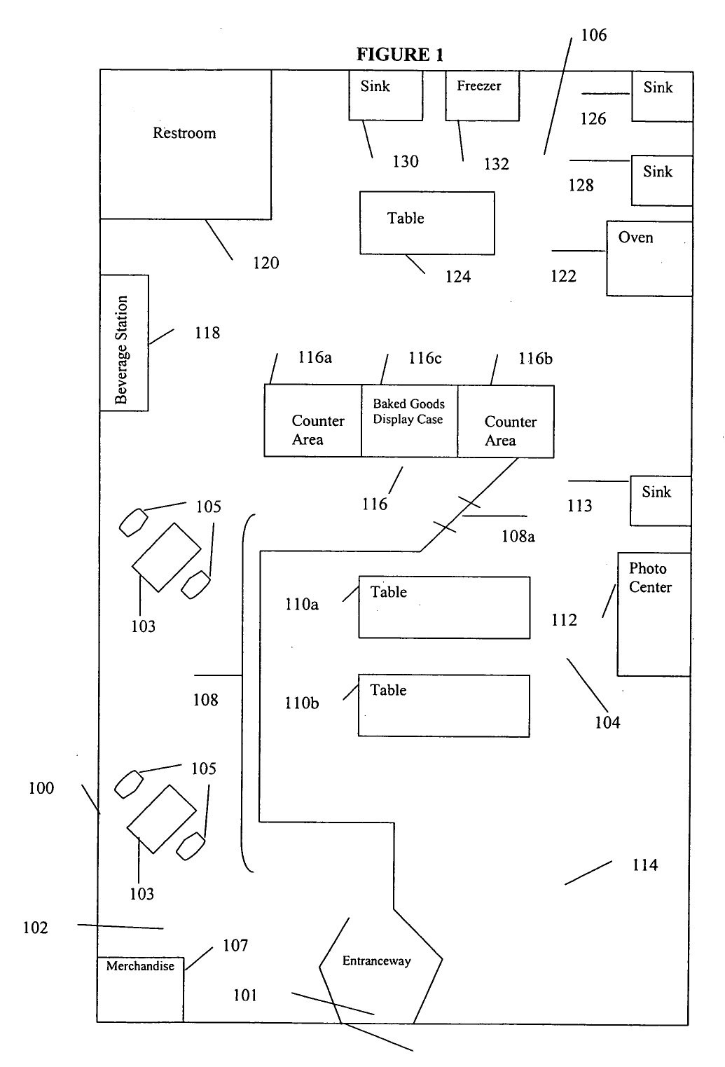

FIG. 1 is a block diagram illustration of an exemplary publicly accessible foodstuff related business location 100. For example, location 100 may be a bakery/café. In such an example, bakery/café 100 may be used for a number of purposes, as will be explained herein. One use of bakery/café 100 is to provide a publicly accessible location for selling bakery goods and other items such as beverages and retail baking themed merchandise. Another use of bakery/café 100 is as an interactive location where baked goods are purchased, decorated, and packaged. In such a use, the bakery/café 100 is interactive in that the customers may roll pre-mixed baking dough, cut baked goods from the dough, and decorate baked goods, amongst other interactive actions. Yet another use of bakery/café 100 is as a location for an event such as a child birthday party, where each of a number of customers (e.g., children attending the party) may roll pre-mixed baking dough, cut baked goods from the dough, and decorate baked goods, amongst other interactive actions. Yet another use of bakery/café 100 is as party packaging facility for providing supplies to customers who desire to have an event at a location other than bakery/café 100 (e.g., the home of the child having a birthday party). In such a use, packages including baked goods (e.g., previously baked cookies or gingerbread houses, pre-mixed baking dough, etc.), as well as other supplies (e.g., decorating supplies, baked good packaging, and labels for the packages) are provided.

As shown in FIG. 1, bakery/café 100 includes entrance 101, through which customers enter the business location. Generally speaking, bakery/café 100 is divided up into three primary areas: general customer access area 102, guest activity area 104, and employee use area 106. General customer access area 102 is separated from guest activity area 104 using fence 108. Through the use of fence 108, a level of control is provided is to ensure that only certain guests may access guest activity area 104, and that certain guests (e.g., children or adults) are impeded from leaving guest activity area 104. Access from general customer access area 102 to guest activity area 104 is provided through gate 108a in fence 108. Handwashing sink 113 is provided so that customers going to guest activity area 104 can wash there hands before participating in the interactive baking process described herein.

In addition to being a thruway to the remainder of bakery/café 100, general customer access area 102 includes tables 103 and chairs 105. These tables may be utilized by certain customers (e.g., parents) while other customers (e.g., children of the parents) are participating in a baking and/or decorating process in guest activity area 104. Alternatively, general customer access area 102 may also be used to conduct the baking related activities discussed herein. Merchandise area 107 is provided so that customers may select and purchase certain items, for example, bakery themed items (e.g., cookie cutters, rolling pins, decorating supplies, etc.).

Guest activity area 104 includes play area 114 (e.g., that may include toys, games, and other child related entertainment activities), as well as tables 110a and 110b. Tables 110a and 110b are provided for guest activities related to baked goods or other foodstuff related products. Such guest activities may include rolling a pre-mixed baking dough compound, cutting the compound into desired shapes, and decorating baked goods. Guest activity area 104 also includes photo center 112, for taking digital pictures of guests, as will be described herein.

The supplies provided to customers for use in guest activity area 104 may include rolling pins for rolling a pre-mixed baking dough compound and cookie cutters for cutting the rolled compound. The cookie cutters may be tailored to an event (e.g., a birthday party) or an occasion (e.g., a holiday) Such cookie cutters may include Halloween designs (e.g., pumpkins, ghosts), Christmas designs (e.g., candy canes, bells), as well as cutters for any of a number of occasions. Guest activity area 104 may also include decorations for the baked goods including icing, sprinkles, candies, popsicle sticks, etc. These decorations may also be tailored to a particular event or an occasion.

Employee use area 106 includes a number of employee related items, for example, oven 122, table 124, hand washing sink 126, foodstuff sink 128, sink 130, and freezer 132. Counter 116, coffee station 118, and bathroom 120 separate general customer access area 102 from employee use area 106. Counter 116 includes right counter area 116a and left counter area 116b. Counter 116 also includes baked good display case 116c.

According to an exemplary embodiment of the present invention, a guest or customer purchases certain baked goods. For example, the guest/customer may be a parent of a child. The parent and child enter bakery/café 100 through entrance 101, and walk into general customer access area 102. After identifying themselves as customers of certain baked goods, the parent and/or child select certain baked goods (e.g., cookies) from baked goods display case 116c. The selected baked goods are removed from baked goods display case 116c (e.g., by an employee of bakery/café 100) and are brought to guest activity area 104. For example, the selected baked goods may be brought to one of tables 110a and 110b. The customer (i.e., the parent and/or child) are then brought to guest activity area 104 through gate 108a.

The customer (e.g., the child and/or adult) is provided with a baker's hat and an apron, and is then brought to the selected baked goods that have been brought to table 110a or 110b. Various baked good decorating supplies are also provided on tables 110a and 110b (e.g., icing, sprinkles, candies, popsicle sticks, etc.). The customer (e.g., the child and/or adult) then decorates at least one of the selected baked goods. The decorated baked goods are packaged into a package (e.g., a box, a bag, a plastic container, etc.).

A digital picture is then taken of the customer (e.g., the child), for example, by an employee of bakery/café 100 using a digital camera. The digital picture is then downloaded as a digital image to a computer that is provided at photo center 112. The digital image is then linked with a label template stored in memory of the computer. The label template including the digital image is then printed into a label at photo center 112. The label is is then applied to the packaged baked goods.

In an alternative embodiment of the present invention, the customers may arrange to cut the baked goods from a pre-mixed baking dough compound (e.g., sugar cookie dough, gingerbread cookie dough, chocolate chip cookie dough, etc.). Upon entering bakery/café 100, the customer selects at least one variety of pre-mixed baking dough compound. Alternatively, the customer may have previously arranged for, and selected, at least one variety of pre-mixed baking dough compound. The selected pre-mixed baking dough compound is brought to table 110a or 110b, where the customer rolls the dough (e.g., using a rolling pin) and cuts the dough into certain shapes (e.g., gingerbread figures, balloons, butterflies, etc.), for example, using cookie cutters. The cut dough is then retrieved by an employee of bakery/café 100 and inserted into an oven (e.g., oven 122) for baking. Although oven 122 is illustrated as being in employee area 106, this is just an example. Alternatively, oven 106 may be provided in an area visible by customers such that they can feel more involved in the baking of the cookies.

After the cookies have been baked they are brought back to guest activity area 104 so that the customer can decorate the cookies as described above, after which the decorated cookies are packaged. The label (including an image of the customer) is then applied to the package, as described above. The packaged cookies (including labels) may be taken home with the customer, eaten by the customer while at the bakery/café, or shipped to an address desired by the customer.

In yet another alternative embodiment of the present invention, an event is held at bakery/café 100. For example, the event may be a child's birthday party, a holiday party, or any of a number of celebratory events. At such an event, bakery/café 100 may provide food (e.g., pizza, sandwiches, snack food) and beverages to customers associated with the event. At such an event, a number of customers (e.g., each of the children attending the party) are provided with the opportunity to decorate baked goods in guest activity area 104. The customers are provided with baking hats (e.g., disposable baking hats) and aprons (e.g., disposable baking aprons). In such a situation, the customers that decorate the baked goods may select the cookies that they would like to decorate from baked goods display case 116c. Alternatively, the customers may be provided with a pre-mixed baking dough compound to roll and cut cookies for baking and subsequent decorating. Further, the baked goods are packaged, and a label is applied to the packages, where the label includes an image of the customer. The image on the label may be of the customer who cuts the cookies and/or decorates the cookies. Alternatively, each of the labels includes the image of a single customer, for example, a child who is the subject of a birthday party.

In yet another alternative embodiment of the present invention, bakery/café 100 provides party or group packages to customers. For example, a customer (e.g., the parent of a child having a birthday party) may arrange an in home party with bakery/café 100. Bakery/café 100 prepares at least one of previously prepared baked goods or a pre-mixed baking dough compound to the customer. In the event that the previously prepared baked goods are provided to the customer, additional materials are provided to the customer, including supplies for decorating the baked goods, packages for the baked goods, and labels for the packages. In such an embodiment, the label may be provided with the image of the child having the birthday party. During the in home birthday party, the customer provides a number of guests (e.g., children at the party) with the baked goods, as well as the decorating supplies. After the guests (e.g., children) decorate the cookies, the decorated cookies are then packaged, and then the labels are applied to the packages.

In yet another exemplary embodiment of the present invention, packaged baked goods including images of customers may be shipped to an address selected by the customer. For example, a customer (e.g., a parent of a child) may wish to send a package of baked goods including the label (with the child's image) to a relative of the child (e.g., a grandparent). Through this shipment, the relative is able to share in the enjoyment of the event.

In an alternative embodiment of the present invention, the activities described herein with respect to bakery/café are not necessarily conducted in a stand alone business. For example, bakery/café 100 may be integrated into a grocery store, a restaurant, a retail store (e.g., a toy store, a. craft store, or a child-related retail store). In such an embodiment, parents may shop while children are participating in the interactive baking process described herein.

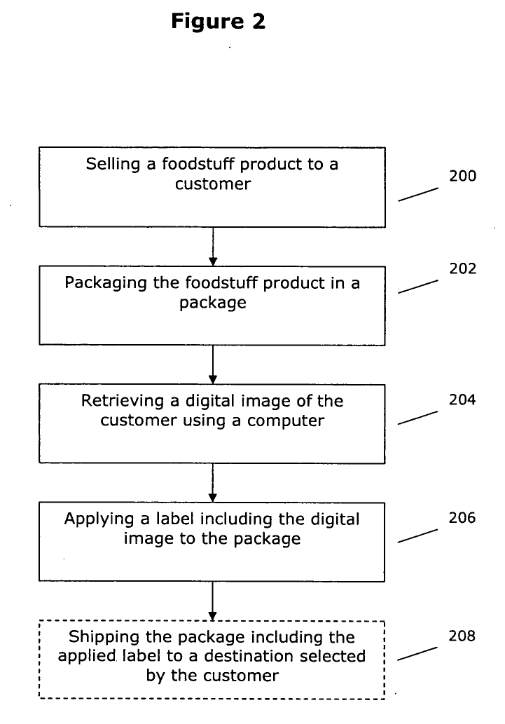

FIG. 2 is a flow diagram illustrating a method of operating a foodstuff related business. At step 200, a foodstuff product is sold to a customer. As provided above,. the sale of the foodstuff product relates to a broad range of sales activities including selling a single baked good, selling a group of baked goods, selling baked goods to an individual, and selling baked goods as part of an event. At step 202, the foodstuff product is packaged. For example, as explained herein, the foodstuff product may be rolled by the customer, cut by the customer, baked, and/or decorated by the customer prior to the packaging at step 202. At step 204, a digital image of the customer is retrieved using a computer, and at step 206, a label including the digital image is applied to the package. At optional step 208, the package including the applied label is shipped to a destination selected by the customer.

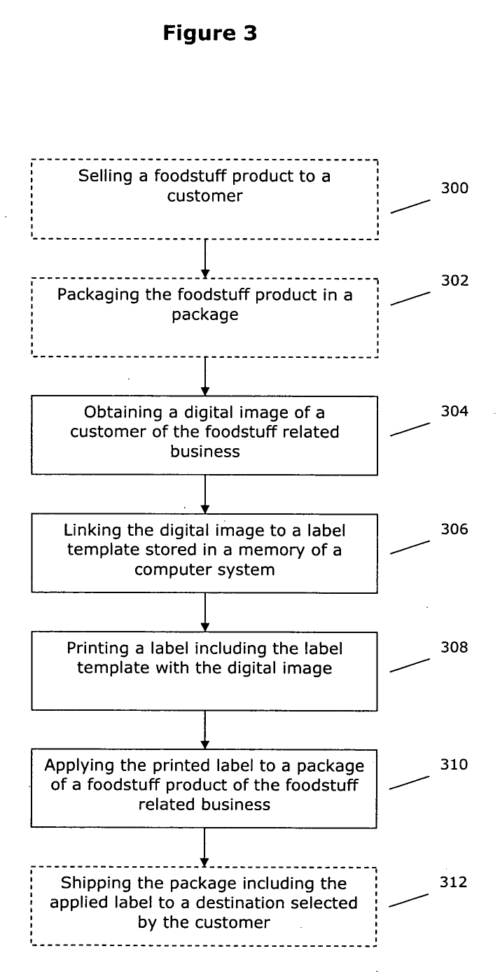

FIG. 3 is another flow diagram illustrating a method of operating a foodstuff related business. At optional step 300, a foodstuff product is sold to a customer, and at optional step 302, the foodstuff product is packaged. At step 304, a digital image of the customer of the foodstuff related business is obtained, for example, using a digital camera. The digital image is linked to a label template stored in a memory of a computer system at step 306. The label including the label template with the digital image is then printed at step 308, and applied to the package at step 310. At optional step 312, the package including the applied label is shipped to a destination selected by the customer.

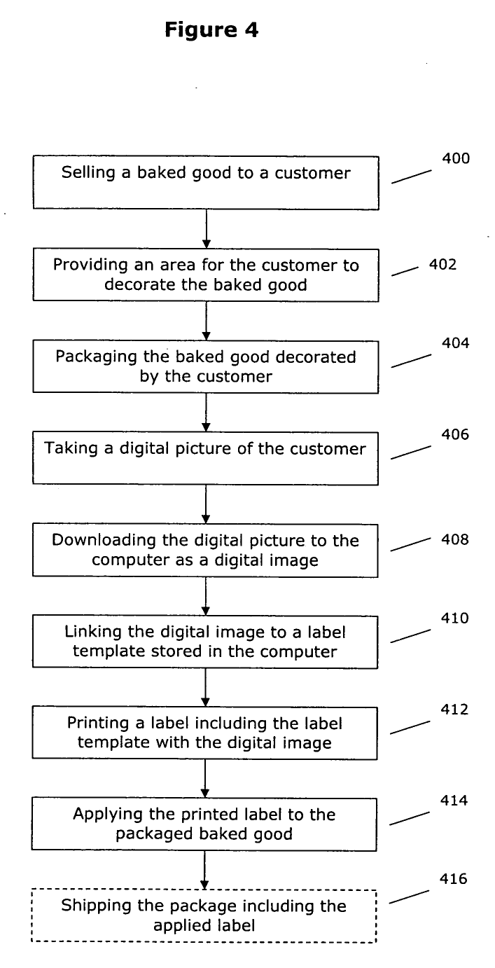

FIG. 4 is a flow diagram illustrating a method of operating a baked goods business. At step 400, a baked good is sold to a customer. At step 402, an area for the customer to decorate the baked good is provided. At step 404, the baked good decorated by the customer is packaged. At step 406, a digital picture of the customer is taken, and the digital picture is downloaded to the computer as a digital image at step 408. At step 410, the digital image is linked to a label template stored in a memory of the computer, and at step 412, a label including the label template with the digital image is printed. At step 414, the printed label is applied to the packaged baked good. At optional step 416, the package including the applied label is shipped to a destination selected by the customer.

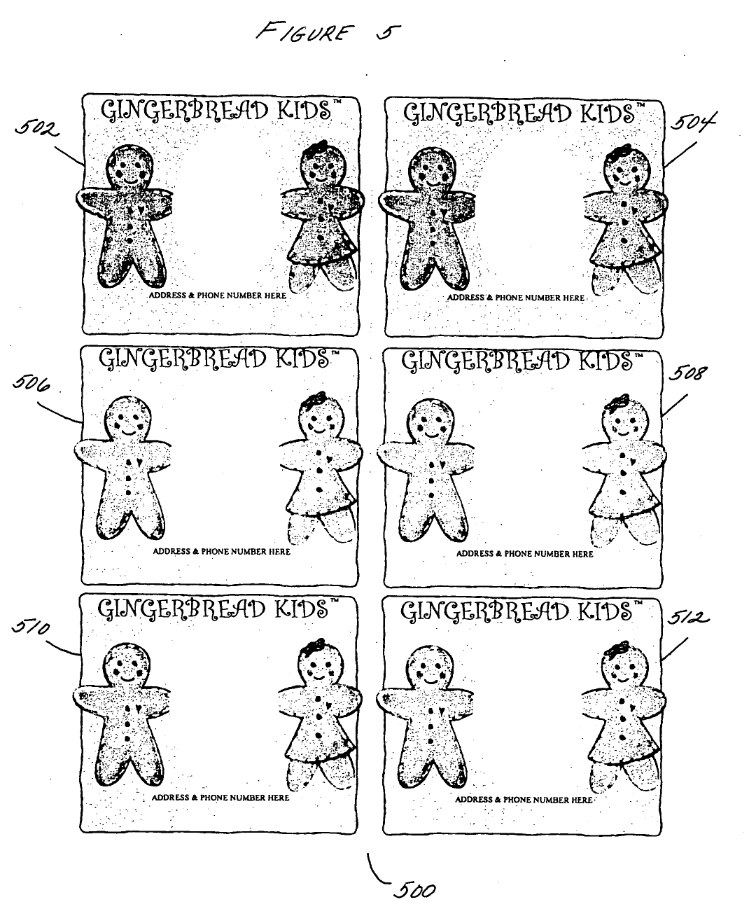

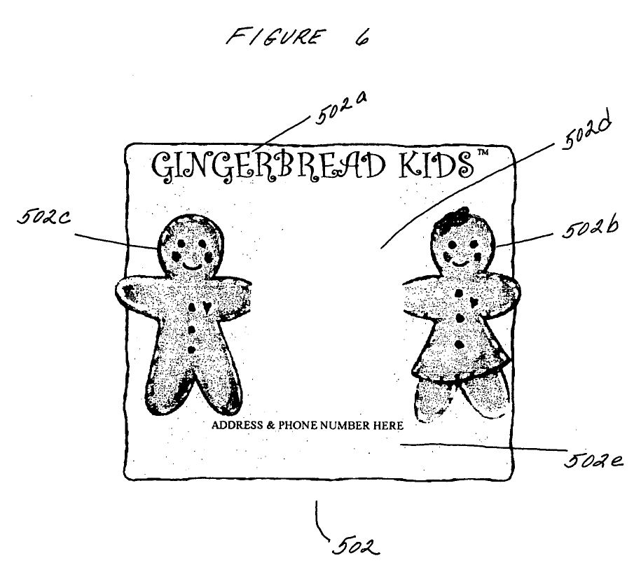

FIG. 5 is an illustration of a group of label templates 500 that may be printed (along with one or more digital images) as a sheet. Group 500 includes label templates 502, 504, 506, 508, 510, and 512. FIG. 6 is a detailed view of label template 502 illustrated in FIG. 5.

As shown in FIG. 6, exemplary label template 502 includes text 502a (i.e., “GINGERBREAD KIDS”), that provides advertising information related to bakery/café 100. Label template 502 also includes design illustrations 502b and 502c (i.e., gingerbread cookies). Further, label template includes text 502e, including, for example, address information and a telephone number for bakery/café 100. Further still, label template 502 includes open area 502d configured to receive a digital image of a customer of bakery/café 100. Alternative or different information or design illustrations may be provided on label template, for example, a customer name (e.g., a child's name having a birthday party, a group name, etc.), a date of an event, a name of an event, etc.

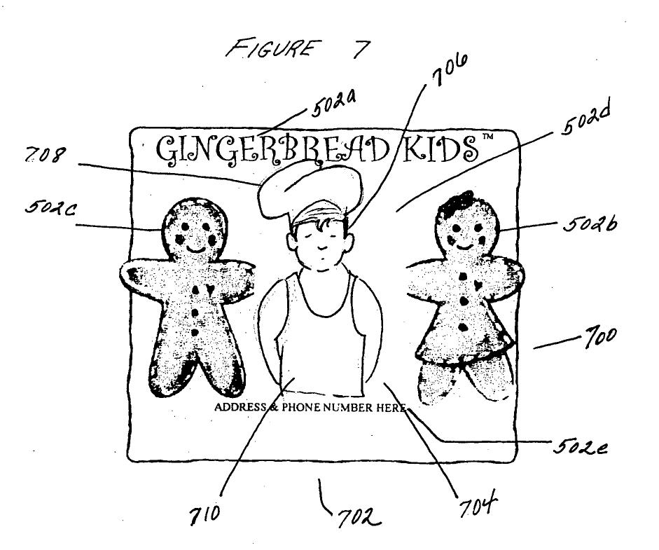

FIG. 7 is an illustration of a label 700, including a label template 702 and digital image 704. As with label template 502, label template 702 includes text 502a, design illustrations 502b and 502c, text 502e, and open area 502d. In FIG. 7, open area 502d has been linked with digital image 704. Digital image 704 is a digital image of a customer of bakery/café 100. For example, the customer may be a child. As shown in FIG. 7, digital image 704 illustrates customer 706 wearing baking hat 708 and apron 710. Baking hat 708 and apron 710 are simply exemplary costume related items that provide the customer with a more involved baking experience, however, other items may be included in the digital image such as oven mitts and kitchen utensils (e.g., rolling pins, cookie cutters, etc.). Alternatively, the customer may elect not to wear or hold these items during the baking activities or in the picture.

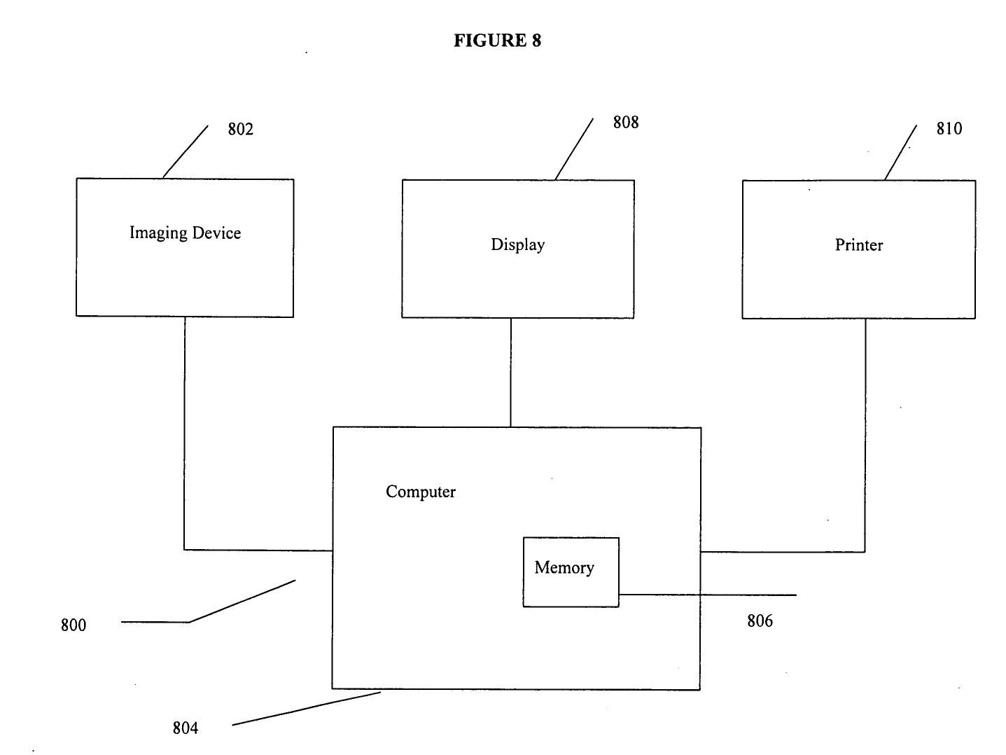

FIG. 8 is a block diagram illustrating a system 800 used to process digital images in accordance with an exemplary embodiment of the present invention. System 800 includes imaging device 802 (e.g., a digital camera) used to take a digital picture of a customer of bakery/café 100. The digital picture is then downloaded to computer 804 as a digital image. The digital image can be viewed on display 808. The digital image is linked with a label template stored in memory 806 in computer 804, thereby forming a label. The label (including the label template with the digital image) is printed using printer 810. As described above, the printed label may be applied to a package of foodstuff items.

In an alternative embodiment of the present invention, the bakery/café offers for sale containers of a pre-mixed baking dough compound (e.g., in a plastic tub or other container) that include a label. As described herein, the label includes a digital image of a customer, a group of customers, a school, a group, etc.

Although the present invention has been primarily described in terms of baked goods, and more specifically cookies, it is not limited thereto. The method of operating a business disclosed herein is applicable to any of a number of foodstuff items, including, for example, gingerbread houses that can be decorated by customers, cakes decorated by customers, pizzas prepared and/or baked by customers, as well as any of a number of alternative foodstuff items.

In certain embodiments disclosed herein, the present invention has been described in terms of children supervised by a parent; however, it is contemplated that children may be supervised by any of a number of adults including employees of the bakery/café, grandparents, siblings, aunts, uncles, friends, babysitters, school teachers, guardians, and various other adult persons.

Although the present invention has been primarily described in terms of a digital image being obtained at the bakery/café location (e.g., using a digital camera), it is not limited thereto. For example, customers may provide digital pictures (e.g., through e-mail) to the bakery/café for integration into a label. Further, the labels do not necessarily require a label template, and as such, a label applied to a foodstuff package may include only an image of the customer.

Although the image on the label applied to the package has primarily been described terms of a single customer (e.g., a child, and adult), it is not limited thereto. For example, a group of customers (e.g., a group of children at an event, a family, a corporate group, twin children, a group of adults) may be included in the image.

Although the decorating process has primarily been described with respect to baked goods, it is not limited thereto. For example, a customer may decorate all baked goods before they are baked. Alternatively, a customer may decorate certain baked goods before baking, and other baked goods after baking.

Although the image on the label has primarily been described as including a customer (e.g., a child/children), it is not limited to people. For example, the image may be of a school building in an embodiment where the packages are distributed to customers connected to the school (e.g., children attending the school, parents of children attending the school, employees of the school, people to whom the school children have sold the packages, etc.). The image may also be of a corporate building, or any other person, place or thing connected to a customer.

Customers of the foodstuff related business of the present invention have been described herein as performing certain activities including rolling a pre-mixed baking dough compound, cutting baked goods from the rolled dough, and decorating baked goods; however, the actual baking process has been largely described as being accomplished by employees of the business, and not by customers. This is partially because customers of the business often include children, and such customers may not be able to safely bake the goods (e.g., using an oven). However, in certain environments with adult customers, or in controlled environments including certain children, baking the goods using an oven may also be accomplished by the customers.

In various exemplary embodiments of the present invention described herein, a package including a foodstuff product is shipped to a location desired by the customer. It is intended that such shipping activities also contemplate delivery activities such as hand deliveries, truck deliveries, etc.

Although the invention is illustrated and described herein with reference to specific embodiments, the invention is not intended to be limited to the details shown. Rather, various modifications may be made in the details within the scope and range of equivalents of the claims and without departing from the invention.

1. A method of operating a foodstuff related business, said method comprising the steps of:
selling a foodstuff product to a customer;
packaging the foodstuff product in a package;
retrieving a digital image of the customer using a computer; and
applying a label including the digital image to the package.

2. The method of claim 1 wherein said selling step includes selling a baked good to the customer.

3. The method of claim 1 wherein said selling step includes selling a cookie to the customer.

4. The method of claim 1 wherein said packaging step includes packaging a baked good in a package, the baked good being at least one of purchased by the customer, selected by the customer, rolled by the customer, cut by the customer, baked by the customer, and decorated by the customer.

5. The method of claim 1 wherein said retrieving step includes taking a digital picture of the customer, downloading the digital picture to a computer as the digital image, and linking the digital image to a label template to form the label.

6. The method of claim 1 wherein said selling step includes providing a work area to decorate baked goods selected by the customer, and said packaging step includes packaging baked goods selected and decorated by the customer.

7. The method of claim 1 wherein said selling step includes providing a pre-mixed baking dough compound to the customer for rolling and cutting, and subsequently providing the rolled and cut compound to the customer as baked goods for decorating, and said packaging step includes packaging the baked goods rolled, cut, and decorated by the customer.

8. The method of claim 1 additionally comprising the step of shipping the package including the applied label to a destination selected by the customer.

9. The method of claim 1 wherein said selling step includes hosting an event during which the customer is provided with baked goods to decorate, and said packaging step includes packaging baked goods decorated by the customer.

10. The method of claim 1 additionally comprising the step of supplying a plurality of said package including the label to the customer such that the customer may host an event during which the packages are distributed to participants of the event.

11. A method of operating a foodstuff related business, said method comprising the steps of:
obtaining a digital image of a customer of the foodstuff related business;
linking the digital image to a label template stored in a memory of a computer system;
printing a label including the label template with the digital image; and
applying the printed label to a package of a foodstuff product of the foodstuff related business.

12. The method of claim 11 wherein said obtaining step includes taking a digital picture of the customer and downloading the digital picture to a computer as the digital image.

13. The method of claim 11 wherein said linking step includes retrieving the label template from the memory of a computer system, personalizing the label template based on the customer, and updating the memory of the computer system to include the personalized label template.

14. The method of claim 11 further comprising the steps of selling the foodstuff product to the customer and packaging the foodstuff product sold to the customer in the package.

15. The method of claim 14 wherein said packaging step includes packaging a baked good in the package, the baked good being at least one of purchased by the customer, selected by the customer, rolled by the customer, cut by the customer, baked by the customer, and decorated by the customer.

16. The method of claim 14 wherein said selling step includes providing a work area to decorate baked goods selected by the customer, and said packaging step includes packaging baked goods selected and decorated by the customer.

17. The method of claim 14 wherein said selling step includes providing a pre-mixed baking dough compound to the customer for rolling and cutting, and subsequently providing the rolled and cut compound to the customer as baked goods for decorating, and said packaging step includes packaging the baked goods rolled, cut, and decorated by the customer.

18. The method of claim 14 wherein said selling step includes hosting an event during which the customer is provided with baked goods to decorate, and said packaging step includes packaging baked goods decorated by the customer.

19. The method of claim 11 additionally comprising the step of supplying a plurality of said package including the label to the customer such that the customer may host an event during which the packages are distributed to participants of the event.

20. The method of claim 11 additionally comprising the step of shipping the package including the applied label to a destination selected by the customer.

21. A method of operating a baked goods business, said method comprising the steps of:
selling a baked good to a customer;
providing an area for the customer to decorate the baked good sold to the customer;
packaging the baked good decorated by the customer;
taking a digital picture of the customer;
downloading the digital picture to the computer as a digital image;
linking the digital image to a label template stored in a memory of the computer;
printing a label including the label template with the digital image; and
applying the printed label to the packaged baked good.

22. The method of claim 21 wherein said selling step includes providing a pre-mixed baking dough compound to the customer to cut the compound into a shape to form the baked good.

23. The method of claim 21 further comprising the step of shipping the packaged baked good including the applied label to a destination selected by the customer.
